(19) United States
(12) Patent Application Publication
(10) Pub. No.: US 2025/0323341 A1
(43) Pub. Date: Oct. 16, 2025

(54) METHOD FOR REGULATING A PRESSURE OF A DIELECTRIC LIQUID CIRCULATING WITHIN A COOLING SYSTEM

(71) Applicant: AMPERE S.A.S., Boulogne Billancourt (FR)

(72) Inventor: Stephane RUBY, Guyancourt Cedex (FR)

(73) Assignee: AMPERE S.A.S., Boulogne Billancourt (FR)

(21) Appl. No.: 18/721,359

(22) PCT Filed: Dec. 12, 2022
(86) PCT No.: PCT/EP2022/085319

§ 371 Date: Nov. 13, 2024

(30) Foreign Application Priority Data
Dec. 21, 2021 (FR) FR2114195

(51) Int. Cl. H01M 10/63; H01M 10/44; H01M 10/48; H01M 10/613; H01M 10/625; H01M 10/6567

(52) U.S. Cl. CPC H01M 10/63; H01M 10/44; H01M 10/48; H01M 10/6567; H01M 10/613; H01M 10/625

(57) ABSTRACT

A method is for regulating a pressure of a dielectric liquid circulating within a cooling system of at least one battery cell of an at least in part electrically propelled vehicle. The cooling system includes a circuit in which the dielectric liquid circulates. The battery cell is immersed in the dielectric liquid. The cooling system includes structure for pressurizing the dielectric liquid within the circuit.

The present invention relates to the field of cooling a battery module for a hybrid or fully electric vehicle. The invention more particularly concerns a method for regulating a pressure configured to keep the cooling system under suitable operating conditions.

Automobile manufacturers seek to improve the performance and range of the batteries of electric vehicles. These manufacturers also seek to reduce the time needed to charge the batteries of such vehicles. These improvements can give rise to new constraints being placed on the batteries, such as:
considerable cooling being necessary in order to allow faster charging of the battery;
it being necessary to constantly apply a considerable pressure to the battery cells in order to improve their service life and their performance, and also user safety;
it being necessary to manage the variations in volume of the battery cells during successive charging and discharging operations and/or as they age.

The prior art comprises specific cooling systems configured to manage the pressure and the temperature that are applied to the battery cells. However, such systems are not utilized in the best conditions, and this adversely affects the service life and the performance of the batteries of electric vehicles. The charging and discharging steps are not anticipated and the pressure within these systems is not correctly managed to obtain the best service life and performance for a battery.

In particular, patent application DE102018215477 describes the use, in a battery module, of a piston system, a pump and a pressure sensor in order to regulate the pressure of a cooling fluid in which electrochemical cells are partially immersed. The fluid circuit comprises an expansion vessel and is therefore substantially at atmospheric pressure. The fluid is therefore pressurized by the pump, since the piston is only present to compensate for the variations in volume of the cells. The pump must constantly generate a very high pressure, equal to the pressure to which the cells are to be compressed increased by the loss of hydraulic head in the circuit, which is to say a total pressure of about 3 bar, for example. Such a pump is heavy, bulky and expensive, assuming such a pump even exists.

The present invention provides a pressure regulating method for adapting the pressure within the cooling circuit according to the forthcoming operating mode, notably a charging or discharging phase. Such a method makes it possible to take better account of the various steps of the life cycle of the electrochemical cells used to drive a vehicle.

The main objective of the present invention is therefore a method for regulating a pressure of a dielectric liquid circulating within a cooling system for cooling at least one cell of a battery of an at least partially electric vehicle, the cooling system comprising a circuit which is entirely filled with the dielectric liquid and in which this dielectric liquid circulates, the cell of the battery being immersed in the dielectric liquid, the cooling system comprising a pressurizing means for pressurizing the dielectric liquid within the circuit and a detecting member for detecting the pressure of the dielectric liquid within the circuit, the regulation method comprising at least the following steps:
a first step of preparing for the charging of the cell of the battery during which the dielectric liquid pressurizing means brings, for example increases or decreases, the pressure within the circuit to a first pressure,
a second step of charging the cell of the battery during which the pressurizing means maintains the first pressure within the circuit,
a third step of preparing for the discharging of the cell of the battery during which the dielectric liquid pressurizing means brings, for example increases or decreases, the pressure within the circuit to a second pressure,
a fourth step of discharging the cell of the battery during which the pressurizing means maintains the second pressure within the circuit.

The cooling system comprises a circuit in which the dielectric fluid circulates, the cell of the battery being immersed in the dielectric liquid.

The dielectric liquid is a liquid designed to come into contact with various electric members without generating a short circuit.

The cooling system comprises a pressurizing means for pressurizing the dielectric liquid within the circuit, it being possible for the pressurizing means to be an electrically controlled piston. Such a system makes it possible to generate a pressure, for example equal to 4 bar, thereby making it possible to make the cells function in optimum conditions in terms of performance, durability and safety when subjected to a charging and discharging cycle.

The pressure implemented during the first preparation step establishes the necessary pressure in the circuit to reduce the time needed to charge the cell and maximize the service life of the cell.

In the second step, the pressurizing means maintains the first pressure in the circuit by adapting its position courtesy of an electric actuator which acts on the piston of the pressurizing means.

During the third step, which corresponds to preparing for the discharging of the cell of the battery, the dielectric liquid pressurizing means brings, for example reduces, the pressure of this liquid within the circuit to a second pressure which corresponds to the necessary pressure in the circuit to optimize the discharge of the cell and maximize the service life of this battery cell.

In the fourth step, which corresponds to discharging the cell of the battery, the pressurizing means maintains the second pressure within the circuit, notably by adapting its position courtesy of the aforementioned electric actuator.

Advantageously, the pressure regulating method makes use of at least two pressure thresholds, a first pressure threshold being designed for charging whereas a second pressure threshold is designed for discharging. Such a configuration of the regulation method makes it possible to slow down the aging of the battery cells, optimize their performance and/or limit heat losses therefrom.

According to one feature, the cooling system comprises at least one circulating means for circulating said dielectric liquid within the circuit. According to the invention, the circulating means, notably when it takes the form of a pump, and the dielectric liquid pressurizing means, notably when it takes the form of a cylinder, cooperate with one another to establish the pressure within the circuit, for example the first pressure or the second pressure.

According to another feature of the invention, the first step, the second step, the third step and the fourth step form a cycle which is repeated multiple times.

According to another feature of the invention, the pressurizing means comprises at least one piston, which is in contact with the dielectric liquid and is moved by an electric actuator, the first pressure being maintained during the second step or the second pressure being maintained during the fourth step by moving the piston.

In a first scenario, the movement performed by the piston may be an axial translational movement, in order to maintain the pressure by moving the piston forward or retreating the piston along this same axis.

In a second scenario, the movement performed by the piston may be a rotational movement, the shape of the piston and the chamber filled with the dielectric liquid being configured to compress, and relieve the pressure on, the dielectric liquid within the cooling system.

According to another feature of the invention, the first pressure is maintained during the second step by retreating the piston, which is to say by releasing the force generated by the piston on the dielectric liquid. The first pressure is maintained during the second step by the piston, which relieves the pressure on the dielectric liquid as the cell charges and increases in volume.

According to another feature of the invention, the second pressure is maintained during the fourth step by moving the piston forward, which is to say by increasing the force generated by the piston on the dielectric liquid. The second pressure is maintained during the fourth step by the piston, which compresses the dielectric liquid as the cell discharges and its volume decreases.

It will be noted that the first pressure is higher than the second pressure, in this example.

According to another feature of the invention, the movement of the pressurizing means is made dependent on the pressure detected by the detecting member.

The pressure detecting member may be equated to a pressure sensor, the information on pressure in the circuit being sent to a computer which controls the change in position of the piston in order to regulate the pressure, in response to the charging or discharging of the cell.

According to another feature of the invention, before any one of the first to fourth steps, a step of applying a vacuum in the circuit is implemented.

The vacuum is applied in order to minimize the presence of gas in the circuit.

According to another feature of the invention, the circuit is entirely filled with dielectric liquid. This is understood to mean that, during normal operation, no portion of the circuit is in contact with a fluid other than the dielectric liquid.

According to another feature of the invention, before the first step, the pressurizing means brings the dielectric liquid from atmospheric pressure to a pressure corresponding to a state of charge of the cell of the battery, for example the first pressure, the second pressure or any other pressure.

When the cooling system is started up for the first time or has work performed on it, the circuit is filled with dielectric liquid and is hermetically closed, at atmospheric pressure. Subsequently, a first movement of the pressurizing means brings the dielectric liquid to the pressure needed for the level of charge of the battery.

According to another feature of the invention, the cooling system comprises at least one heat exchanger configured to discharge the heat energy present in the dielectric liquid to an external environment.

The circulating means can be equated to a pump for circulating the dielectric fluid within the circuit; by performing this circulation, the pump thus overcomes the losses of hydraulic head in the cooling system and assists in maintaining the system at a constant pressure. The losses of hydraulic head in the system are approximately 0.5 bar. It is the pressurizing means which raises the static pressure in the circuit to a value approximately equal to 3.5 bar. These pressure values are given by way of example but they are illustrative of the proportions. The pump may therefore have its size and weight reduced, and also reduce its consumption compared to a system of the prior art, and consequently improve the electric range of the electric vehicle.

The heat exchanger forms part of the circuit and makes it possible to discharge the heat energy accumulated in the dielectric liquid to an external environment, the heat energy being caused by the heating of the battery cells.

The invention also targets a cooling system for cooling at least one cell of a battery of an at least partially electric vehicle, the cooling system comprising a circuit which is entirely filled with the dielectric liquid and in which this dielectric liquid circulates, the cell of the battery being immersed in the dielectric liquid, the cooling system comprising at least one pressurizing means for pressurizing the dielectric liquid within the circuit, a circulating means for circulating said dielectric liquid within the circuit, a detecting member for detecting the pressure of the dielectric liquid within the circuit and a heat exchanger configured to discharge the heat energy present in the dielectric liquid to an external environment, characterized in that the circulating means circulates the dielectric liquid in the circuit while the pressurizing means maintains the dielectric liquid above atmospheric pressure.

In the present document, the term “cell” is used to denote both a single cell and a set of cells forming a battery, multiple batteries assembled close to one another then being referred to either as battery pack or battery module.

Other features, details and advantages of the invention will become more clearly apparent from reading the following description on the one hand, and from exemplary embodiments given by way of nonlimiting indication, with reference to the appended drawings on the other, in which:

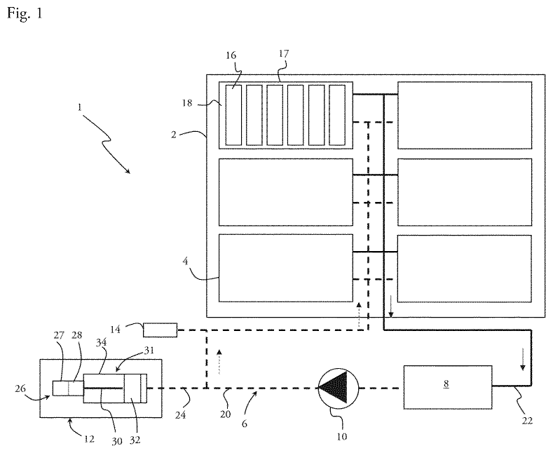

FIG. 1 schematically illustrates a cooling system for cooling a battery pack,

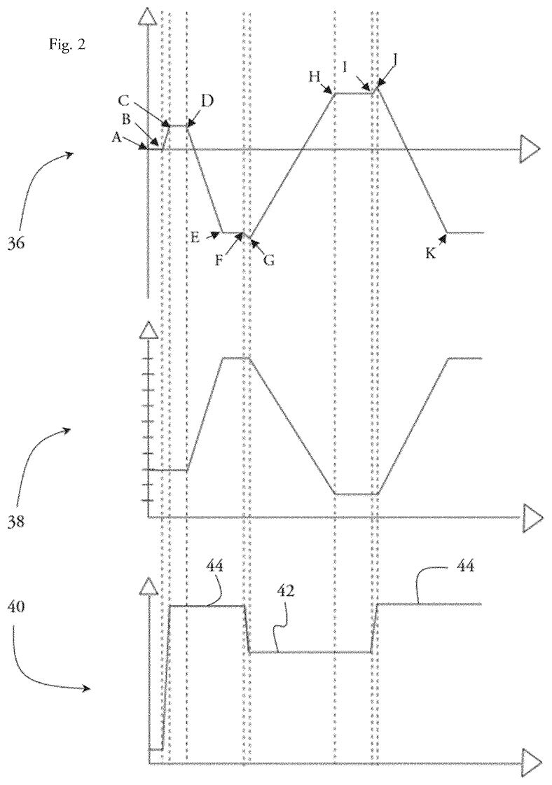

FIG. 2 illustrates a pressure regulating method according to the invention, applied to a cooling system from FIG. 1.

The features, variants and different embodiments of the invention may be combined with one another, in various combinations, provided that they are not incompatible with one another or mutually exclusive. In particular, it is possible to envisage variants of the invention that comprise only a selection of features that are described below in isolation from the other described features, if this selection of features is sufficient to provide a technical advantage and/or to differentiate the invention from the prior art.

FIG. 1 illustrates a cooling system 1 for cooling a battery pack 2.

A battery 4 is an electrical storage element intended to supply electrical energy at least to an engine for driving a vehicle equipped with the cooling system.

The cooling system 1 shown in FIG. 1 therefore comprises a plurality of batteries 4 inside which a dielectric fluid circulates. The cooling system also comprises a circuit 6 which has the role of channeling the dielectric liquid between each component of the cooling system 1.

The cooling system 1 further comprises a heat exchanger 8 and a dielectric liquid circulating means 10, with the circuit, the heat exchanger 8, the circulating means 10 and the batteries 4 forming a closed loop inside which the dielectric fluid circulates.

The cooling system 1 further comprises a pressurizing means 12 for pressurizing the dielectric liquid within the circuit, and a detecting member 14 for detecting the pressure of the dielectric liquid within the circuit 6.

The cooling system illustrated in FIG. 1 comprises, by way of example, six batteries 4, each of which accommodates multiple cells 16. The battery 4 comprises a chamber 17 which delimits a volume 18 filled with dielectric liquid and inside which the cells 16 are completely submerged, which is to say entirely immersed, in the dielectric liquid. There is therefore no air in the circuit 6.

The dielectric liquid circuit 6 connects each of these six batteries 4 and comprises a pipeline 20 illustrated in dashed line, this pipeline 20 forming an inlet for cooled dielectric fluid for each of the batteries 4. The dielectric liquid circulating within the batteries 4 and along the cells 16 collects the heat energy dissipated by each of the cells 16 and this heated dielectric liquid is sent to the heat exchanger 8 through a pipe 22, illustrated in solid line in FIG. 1.

The circuit 6 is thus made up of a supply portion 20, which starts at the outlet of the heat exchanger 8 and ends at the inlet of at least one of the batteries 4, and a collection portion 22, which starts at the outlet of at least one of the batteries 4 and ends at the inlet of the heat exchanger 8.

The heat exchanger 8 is a component intended to discharge the heat energy present in the dielectric liquid to an external environment, which may for example be a stream of air which passes through the heat exchanger 8 or another heat-transfer liquid. The heat exchanger 8 is placed directly downstream of the batteries 4, in the direction of circulation of the dielectric liquid within the circuit 6, so as to be able to rapidly discharge the heat energy collected at the cells 16.

The circulating means 10 is disposed on the circuit 6 immediately downstream of the heat exchanger 8. According to one exemplary embodiment, the circulating means 10 is a pump activated by an electric motor. The role of this pump is to make the dielectric liquid circulate within the circuit 6, within the batteries 4 and within the exchanger 8, forming the closed circuit.

The pressurizing means 12 is connected to the circuit by an arm 24 external to the circuit 6, the arm being connected to the circuit 6, for example, between an outlet of the circulating means 10 and an inlet of at least one of the batteries 4, any other position for connection to the circuit falling within the scope of the invention.

The pressurizing means 12 comprises an electric actuator 26 composed of an electric motor 27 and a mechanical system 28 for transforming the rotation of the electric motor 27 into a translational movement. This translational movement makes it possible to move a pin 30 of a piston 32 and therefore to move the piston 32 in a body 34. The piston 32 is in contact with the dielectric liquid. The body 34, the piston 32 and the pin 30 form a cylinder 31.

The role of this pressurizing means 12 is to maintain the entire circuit 6 under homogeneous and continuous pressure conditions, according to the charging or discharging phase of the cycle. Since the dielectric liquid is not very compressible at all, the movement of the piston 32 is therefore reduced in order to reach the pressures necessary for the circuit 6 to function properly.

According to the invention, the pressurizing means 12 is responsible for the static pressure within the circuit 6, whereas the circulating means 10 is responsible for the dynamic pressure necessary for making the dielectric liquid circulate within the circuit. Such a design is advantageous in that it makes it possible to use a simpler and less costly circulating means and reduces the electrical consumption of the invention, thus making it possible to increase the electric range of the vehicle.

FIG. 2 illustrates the method for regulating the pressure in the cooling system. The regulation method makes it possible to adapt the pressure within the circuit 6 for a better service life and better performance of the battery pack 2.

The pressure regulating method illustrated in FIG. 2 is shown on three graphs 36, 38, 40, the timelines of each of these graphs being the same.

A first graph 36 shows the position of the piston 32 in the body 34 of the cylinder 31 on the ordinate axis and the time on the abscissa axis. A second graph 38 shows the level of charge of a cell in percent on the ordinate axis, and the time on the abscissa axis. FIG. 2 comprises a last graph 40, showing the pressure in bar in the circuit 6 on the ordinate axis and the time on the abscissa axis.

The three graphs 36, 38, 40 present in FIG. 2 are chronologically linked to one another in the sense that their abscissa axes represent the time on the same scale and starting at the same instant.

The curves of these three graphs 36, 38, 40 change together over time, the position of the piston 32 and the pressure in the circuit 6 depending on the charging or discharging of the battery 2. The dashed lines extending between these three graphs 36, 38, 40 illustrate a change in pressure, cycle or level of charge or a change in position of the pressurizing means 12, or an intermediate waiting step between two active steps (for example between E and F).

The pressure regulating method comprises, between F and G, a step of preparing for the discharging of the battery pack 2. This preparation is characterized by a movement of the piston 32, this making it possible to relieve the pressure in the circuit 6 and reach the second pressure, corresponding to a pressure established before a step of discharging the cell.

The third graph 40 makes it possible to note that, according to this exemplary embodiment, the second pressure, also referred to as discharging pressure 42 of the battery pack 2, is lower than the first pressure, also referred to as charging pressure 44. Between the points G and H, the battery pack 2 is being discharged, notably owing to the fact that it supplies its electrical energy to an engine for driving the vehicle. It will be understood here that the electric vehicle is in a running phase.

During this discharging phase or step, the volume of the cells 16 drops. This drop in volume manifests itself in a reduction in pressure of the dielectric liquid in the circuit 6. This reduction in pressure is then captured by the pressure detecting member 14 which, via a control module which implements the regulation system, instructs the pressurizing means to move so as to keep the second pressure constant in the circuit 6. According to one example, the piston 32 moves forward and keeps exerting force on the dielectric liquid, continuously and proportionally to the discharge taking place in the battery cell. A constant pressure on the cell throughout its discharging phase is thus ensured.

The pressure regulating method comprises, between points I and J, a step of preparing for the charging of the cell 16 of the battery pack 2. This preparation is characterized by a movement of the piston 32 which increases the force it exerts on the dielectric liquid, thereby making it possible to compress the circuit 6 and reach the charging pressure 44.

From the third graph 40, it can be noted that the charging pressure 44 of the battery pack 2 is higher than the discharging pressure 42, according to this exemplary embodiment.

The preparing steps called first step and third step are phases which aim both to give the dielectric fluid a pressure corresponding to the step immediately following the preparing step in question, and to anticipate the charging or discharging phase that immediately follows the preparing step.

Between the points J and K, the cell of the battery pack 2 is being charged. It will be understood here that the electric vehicle is for example in a parked state, connected to a charging terminal.

While being charged here, the volumes of the cells 16 of the battery 4 increase. This rise in volume increases the pressure in the circuit 6 and this increase in pressure is captured by the pressure detecting member 14. The pressurizing means moves to keep the first pressure constant in the circuit 6. Thus, the piston 32 retreats, thus reducing the load it exerts on the dielectric liquid, in order to keep a constant pressure in the circuit 6 during this charging step.

The steps FG, GH, IJ and JK form a cycle and are repeated throughout the service life of the battery pack 2. This cycle comprises two pressure thresholds within the circuit 6, a first pressure threshold corresponding to a charging pressure 44 and a second threshold corresponding to a discharging pressure 42 of the cell, of the battery or of the battery pack.

Between the points A and B, the batteries 4 are filled with dielectric fluid, which is at atmospheric pressure. A vacuum is applied in the circuit 6 beforehand so as to avoid the presence of air in the circuit.

The third graph 40 of FIG. 2 shows that the circuit 6 is brought to the first pressure when passing from point B to point C. The circuit 6 is set to the charging pressure 44 since, in this particular case illustrated here, the battery pack 2 is 30% charged. The next phase will therefore be a step of charging the battery pack 2. Changing from atmospheric pressure to the first pressure, corresponding to the passage from point B to point C, is realized by the pressurizing means, which increases the force it exerts on the dielectric liquid.

In another use case, the battery pack 2 may be charged and the circuit 6 will first of all be brought to the second pressure, which is to say the discharging pressure 42.

The steps AB and BC are performed when the cooling system according to the invention is first started up and/or during a maintenance operation on the battery pack 2.

When the battery pack 2 is 100% charged, the charging is stopped, and the piston 32 therefore no longer moves and the pressure in the circuit 6 remains constant.

The phases between the points C and D, between the points E and F and between the points H and I are waiting phases before a charging step or a discharging step.

The invention, as has just been described, indeed achieves its stated aim, and makes it possible to provide a cooling system for cooling a pack of batteries in which the pressure of the dielectric liquid is kept constant during the two essential phases of a battery, which is to say its charging phase and its discharging phase. According to the invention, this management of the pressure is anticipated by the pressurizing means. The cooling system is particularly appealing in that it makes it possible to use a simple, cheap and energy-efficient circulating means, since the pump only overcomes the losses of hydraulic head in the circuit and not the additional losses of head of the setpoint pressure which forms the static pressure of the circuit. Variants that are not described here may be implemented without departing from the context of the invention, provided that, in accordance with the invention, they implement a regulation method according to the invention.

1-11. (canceled)

12. A method for regulating a pressure of a dielectric liquid circulating within a cooling system for cooling at least one cell of a battery of an at least partially electric vehicle, the cooling system comprising a circuit which is entirely filled with the dielectric liquid and in which the dielectric liquid circulates, the cell of the battery being immersed in the dielectric liquid, the cooling system comprising a pressurizing means for pressurizing the dielectric liquid within the circuit and a detecting member for detecting the pressure of the dielectric liquid within the circuit, the regulation method comprising:
a first step of preparing for the charging of the cell of the battery during which the dielectric liquid pressurizing means brings the pressure within the circuit to a first pressure;
a second step of charging the cell of the battery during which the pressurizing means maintains the first pressure within the circuit;
a third step of preparing for the discharging of the cell of the battery during which the dielectric liquid pressurizing means brings the pressure within the circuit to a second pressure, the first pressure being higher than the second pressure; and
a fourth step of discharging the cell of the battery during which the pressurizing means maintains the second pressure within the circuit.

13. The regulation method as claimed in claim 12, wherein the cooling system comprises at least one circulating means for circulating said dielectric liquid within the circuit.

14. The regulation method as claimed in claim 12, wherein the first step, the second step, the third step, and the fourth step form a cycle which is repeated multiple times.

15. The regulation method as claimed in claim 12, wherein the pressurizing means comprises at least one piston, which is in contact with the dielectric liquid and is moved by an electric actuator, the first pressure being maintained during the second step or the second pressure being maintained during the fourth step by moving the piston.

16. The regulation method as claimed in claim 15, wherein the first pressure is maintained during the second step by retreating the piston.

17. The regulation method as claimed in claim 15, wherein the second pressure is maintained during the fourth step by moving the piston forward.

18. The regulation method as claimed in claim 12, wherein, during the regulation method, movement of the pressurizing means is made dependent on the pressure detected by the detecting member.

19. The regulation method as claimed in claim 18, wherein, during the regulation method, before the first step, the pressurizing means brings the dielectric liquid from atmospheric pressure to a pressure corresponding to a state of charge of the cell of the battery.

20. The regulation method as claimed in claim 12, wherein, during the regulation method, before any one of the first to fourth steps, a step of applying a vacuum in the circuit is implemented.

21. The regulation method as claimed in claim 20, wherein, during the regulation method, before the first step, the pressurizing means brings the dielectric liquid from atmospheric pressure to a pressure corresponding to a state of charge of the cell of the battery.

22. The regulation method as claimed in claim 12, wherein the cooling system comprises at least one heat exchanger configured to discharge the heat energy present in the dielectric liquid to an external environment.

23. A cooling system for cooling at least one cell of a battery of an at least partially electric vehicle, the cooling system comprising:
a circuit which is entirely filled with the dielectric liquid and in which this dielectric liquid circulates, the cell of the battery being immersed in the dielectric liquid;
at least one pressurizing means for pressurizing the dielectric liquid within the circuit;
a circulating means for circulating said dielectric liquid within the circuit;
a detecting member for detecting the pressure of the dielectric liquid within the circuit; and
a heat exchanger configured to discharge the heat energy present in the dielectric liquid to an external environment, the circulating means circulating the dielectric liquid in the circuit while the pressurizing means maintains the dielectric liquid above atmospheric pressure,
wherein the pressurizing means comprises an electric actuator including an electric motor and a mechanical system for transforming the rotation of the electric motor into a translational movement.
